(19) United States
(12) Patent Application Publication
(10) Pub. No.: US 2008/0201219 A1
(43) Pub. Date: Aug. 21, 2008

(54) Query classification and selection of associated advertising information

(76) Inventors: Andrei Zary Broder, Menlo Park, CA (US); Marcus Felipe Fontoura, Los Gatos, CA (US); Vanja Josifovski, Los Gatos, CA (US)

Correspondence Address: STATTLER - SUH PC, 60 SOUTH MARKET STREET, SUITE 480, SAN JOSE, CA, 95113, US

(21) Appl. No.: 11/708,273

(22) Filed: Feb. 20, 2007

(51) Int. Cl. G06Q 30/00

(52) U.S. Cl. 705/14

(57) ABSTRACT

A system and method to facilitate classification of search queries and selection of associated advertising information over a network are described. A search query received from a user over a network is processed to retrieve a predetermined number of query results. The predetermined number of query results is further classified to select one or more categories associated with the query results. Finally, advertising information is selected based on the one or more selected categories for further display to the user in connection with the query results.

### TECHNICAL FIELD

The present invention relates generally to the field of network-based communications and, more particularly, to a system and method to facilitate classification of search queries and selection of associated advertising information over a network, such as the Internet.

### BACKGROUND OF THE INVENTION

The explosive growth of the Internet as a publication and interactive communication platform has created an electronic environment that is changing the way business is transacted. As the Internet becomes increasingly accessible around the world, users need efficient tools to navigate the Internet and to find content available on various websites.

Internet portals provide users an entrance and guide into the vast resources of the Internet. Typically, an Internet portal provides a range of search, email, news, shopping, chat, maps, finance, entertainment, and other content and services. The Internet portal further provides advertising information supplied by advertising entities, which target the users of the portal. Thus, it would be advantageous if the information presented to the users is efficiently and properly classified and stored within the portal and the advertising information closely matches the content presented to the users, in particular advertisements presented on search result pages.

### SUMMARY OF THE INVENTION

A system and method to facilitate classification of search queries and selection of associated advertising information over a network are described. A search query received from a user over a network is processed to retrieve a predetermined number of query results. The predetermined number of query results is further classified to select one or more categories associated with the query results. Finally, advertising information is selected based on the one or more selected categories for further display to the user in connection with the query results.

Other features and advantages of the present invention will be apparent from the accompanying drawings, and from the detailed description, which follows below.

### BRIEF DESCRIPTION OF THE DRAWINGS

The present invention is illustrated by way of example and not intended to be limited by the figures of the accompanying drawings in which like references indicate similar elements and in which:

FIG. 1 is a flow diagram illustrating a method to facilitate classification of queries and selection of associated advertising information, according to one embodiment of the invention;

FIG. 2 is a block diagram illustrating an exemplary network-based entity containing a system to facilitate classification of queries and selection of associated advertising information, according to one embodiment of the invention;

FIG. 3 is a block diagram illustrating the system to facilitate classification of queries and selection of associated advertising information, according to one embodiment of the invention;

FIG. 4 is a block diagram illustrating the system to facilitate classification of queries and selection of associated advertising information, according to an alternate embodiment of the invention;

FIG. 5 is a flow diagram illustrating a method to facilitate classification of queries, according to one embodiment of the invention;

FIG. 6 is a flow diagram illustrating a method to facilitate classification of queries, according to an alternate embodiment of the invention;

FIG. 7 is a flow diagram illustrating a method to facilitate selection of advertising information associated with the classified queries, according to one embodiment of the invention;

FIG. 8 is a flow diagram illustrating a method to facilitate selection of advertising information associated with the classified queries, according to an alternate invention;

FIG. 9 is a flow diagram illustrating a method to facilitate classification of queries and selection of associated advertising information, according to an alternate embodiment of the invention;

FIG. 10 is a diagrammatic representation of a machine in the exemplary form of a computer system within which a set of instructions may be executed.

### DETAILED DESCRIPTION

In the following description, numerous details are set forth for purpose of explanation. However, one of ordinary skill in the art will realize that the invention may be practiced without the use of the specific details. In other instances, well-known structures and devices are shown in block diagram form in order not to obscure the description of the invention with unnecessary detail.

In embodiments described in detail below, users or agents of respective users access an entity, such as, for example, a content service provider or network portal, over a network such as the Internet and further input various data, which is subsequently captured by selective processing modules within the network-based entity. The user input typically comprises one or more “events.” In one embodiment, an event is a type of action initiated by the user, typically through a conventional mouse click command, such as, for example, a search query. A search query event occurs when a user submits one or more search terms or keywords within a search query to a web-based search engine. For example, the user may submit the query “Latin Canon” and a corresponding search query event containing the search terms or keywords “Latin,” “Canon,” and “Latin Canon” is recorded. In response to the user query, a web-based search engine returns a plurality of query results, typically links to web pages relevant to the corresponding search query terms. If a user clicks on one of the links, a search click event occurs.

In embodiments described in detail below, the entity classifies the search query and selects one or more categories associated with the query results corresponding to the search query. In addition, the entity selects advertisements to be displayed for the user within the web page containing the query results, such that each advertisement is selected based on the above categories, as described in further detail below.

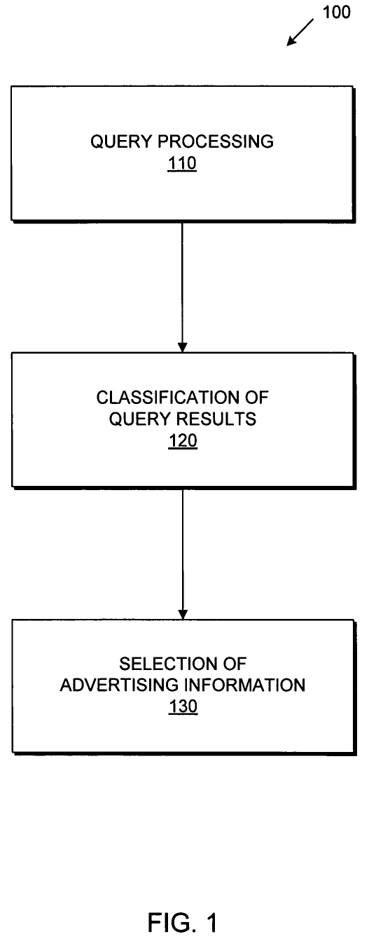

FIG. 1 is a flow diagram illustrating a method to facilitate classification of queries and selection of associated advertising information, according to one embodiment of the invention. As shown in FIG. 1, the sequence 100 starts at processing block 110 with processing of a search query received from a user.

In one embodiment, the user or an agent of the user accesses the entity over a network and inputs a search query containing one or more query terms or keywords. The entity receives the search query and retrieves query results from a data storage module, as described in further detail below.

Referring back to FIG. 1, the sequence 100 continues at processing block 120 with classification of the query results. In one embodiment, the entity classifies the query results and selects one or more categories representative for the search query, as described in further detail below.

Finally, the sequence 100 continues at processing block 130 with selection of advertising information related to the one or more representative categories. In one embodiment, the entity retrieves advertising information that matches the one or more selected categories, as described in further detail below. The advertising information includes multiple advertisements, which may include a hyperlink, such as, for example, a sponsor link, an integrated link, an inside link, or other known link. The format of an advertisement may or may not be similar to the format of the content displayed on the web page and may include, for example, text advertisements, graphics advertisements, rich media advertisements, and other known types of advertisements.

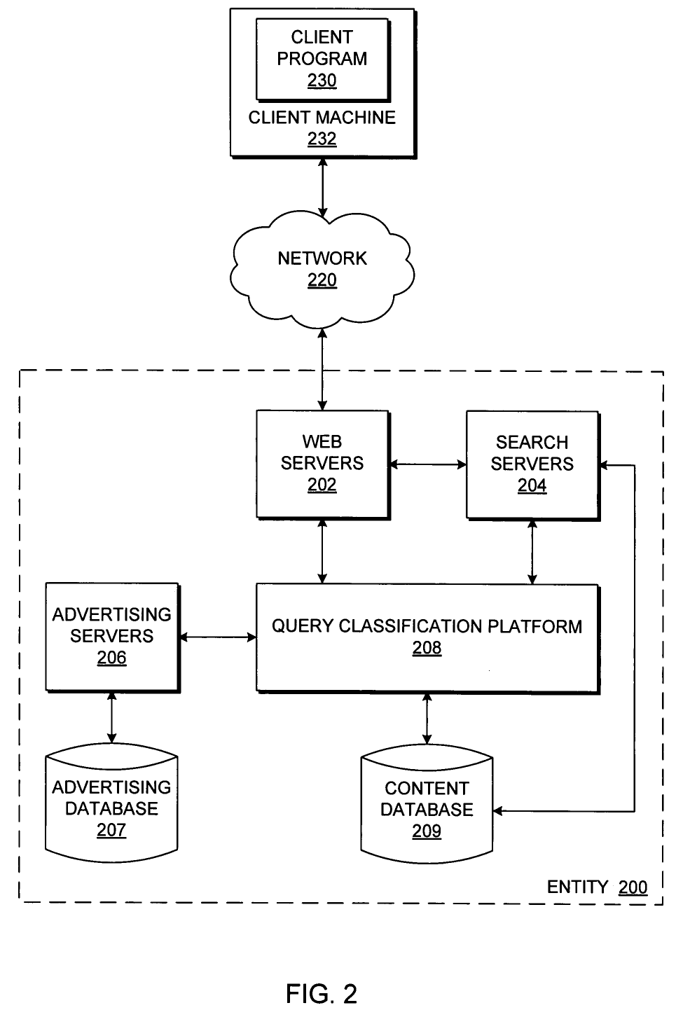

FIG. 2 is a block diagram illustrating an exemplary network-based entity containing a system to facilitate classification of queries and selection of associated advertising information, according to one embodiment of the invention. While an exemplary embodiment of the present invention is described within the context of an entity 200 enabling automatic classification of search queries and selection of associated advertising information, it will be appreciated by those skilled in the art that the invention will find application in many different types of computer-based, and network-based, entities, such as, for example, commerce entities, content provider entities, or other known entities having a presence on the network.

In one embodiment, the entity 200 is a network content service provider, such as, for example, an Internet portal like Yahoo! and its associated properties, and includes one or more front-end web processing servers 202, which may, for example, deliver web pages to multiple users, (e.g., markup language documents), provide automated communications to/from users of the entity 200, deliver images to be displayed within the web pages, deliver content information to the users in various formats. The entity 200 further includes one or more search servers 204 coupled to the web servers 202, which handle search requests received at the entity 200 from one or more users of the entity 200 via the network 220. The entity 200 may further include other processing servers, which provide an intelligent interface to the back-end of the entity 200.

In one embodiment, the entity 200 includes one or more back-end servers, for example, one or more advertising servers 206, and one or more database servers (not shown). Each server maintains and facilitates access to one or more data storage modules, such as, for example, one or more advertising databases 207 and one or more content databases 209. In one embodiment, the advertising servers 206 are coupled to the shown advertising database 207 and are configured to transmit and receive content, such as, for example, advertisements, sponsored links, integrated links, and other types of advertising content, to/from advertiser entities via the network 220. In one embodiment, the entity 200 further includes a system to facilitate classification of queries and selection of associated advertising information within the network-based entity 200, as described in further detail below. The system further comprises a query classification platform 208 coupled to the shown content database 209. The platform 208 is further coupled to the web servers 202, the search servers 204, and the advertising servers 206.

The network-based entity 200 may be accessed by a client program 230, such as a browser (e.g., the Internet Explorer™ browser distributed by Microsoft Corporation of Redmond, Wash., Netscape's Navigator™ browser, the Mozilla™ browser, a wireless application protocol enabled browser in the case of a cellular phone, a PDA or other wireless device), that executes on a client machine 232 of a user entity and accesses the entity 200 via a network 220, such as, for example, the Internet. Other examples of networks that a client may utilize to access the entity 200 includes a wide area network (WAN), a local area network (LAN), a wireless network (e.g., a cellular network), a virtual private network (VPN), the Plain Old Telephone Service (POTS) network, or other known networks.

In one embodiment, other network entities may also access the network-based entity 200 via the network 220, such as, for example, publisher entities (not shown), which communicate with the web servers 202 to populate web pages transmitted by the web servers 202 with appropriate content information, and advertiser entities (not shown), which communicate with the web servers 202 and the advertising servers 206 to transmit advertisements to be displayed in the web pages requested by the user.

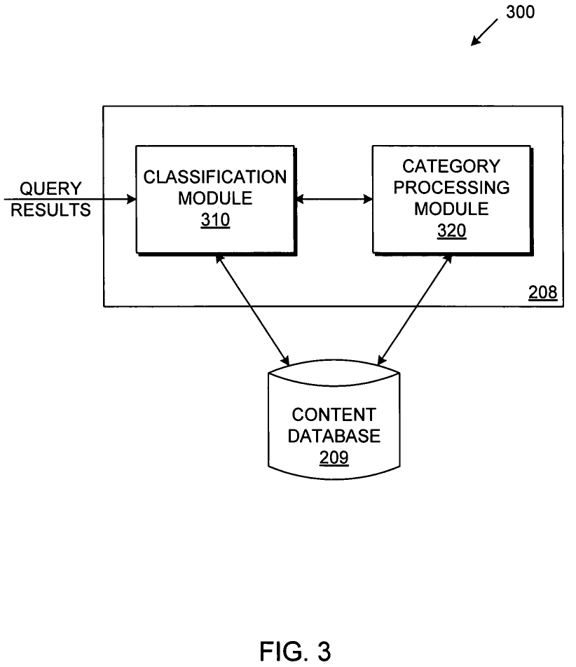

FIG. 3 is a block diagram illustrating the system to facilitate classification of queries and selection of associated advertising information, according to one embodiment of the invention. As illustrated in FIG. 3, the system 300 includes the query classification platform 208 coupled to one or more content databases 209.

In one embodiment, the query classification platform 208 receives query results from the search servers 204 and enables automatic classification of the received query results based on data stored in the associated database 209, as described in further detail below.

In one embodiment, the query classification platform 208 includes a classification module 310, which is a hardware and/or software module configured to receive the query results associated with a search query received from a user and to classify the query results according to one or more categories retrieved from the content database 209, for example, as described in further detail below. The platform 208 further includes a category processing module 320 coupled to the classification module 310 and the content database 209. In one embodiment, the category processing module 320 is a hardware and/or software module configured to receive the one or more retrieved categories from the classification module 310, to generate a ranking of the received categories and to select one or more of the highest ranked categories, as described in further detail below.

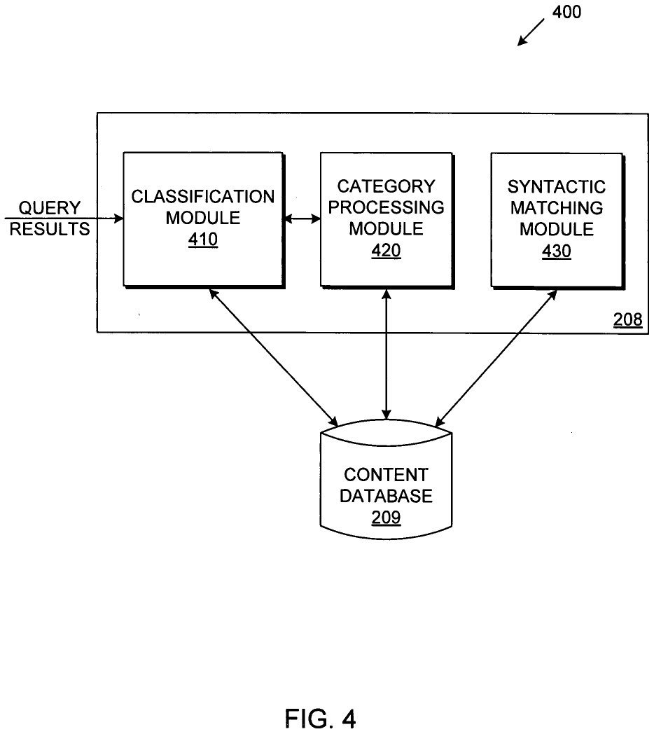

FIG. 4 is a block diagram illustrating the system to facilitate classification of queries and selection of associated advertising information, according to an alternate embodiment of the invention. As illustrated in FIG. 3, the system 400 includes an alternate embodiment of the query classification platform 208 coupled to one or more content databases 209.

In the alternate embodiment, the query classification platform 208 receives query results from the search servers 204 and enables automatic classification of the received query results based on data stored in the associated database 209, as described in further detail below.

The query classification platform 208 includes a classification module 410, which is a hardware and/or software module configured to receive the query results associated with a search query received from a user and to classify the query results according to one or more categories retrieved from the content database 209, for example, as described in further detail below. The platform 208 further includes a category processing module 420 coupled to the classification module 410 and the content database 209. In the alternate embodiment, the category processing module 420 is a hardware and/or software module configured to receive the one or more retrieved categories from the classification module 410, to generate a ranking of the received categories and to select one or more of the highest ranked categories, as described in further detail below. The classification module 410 and the category processing module 420 are similar in functionality to the classification module 310 and the category processing module 320 shown in connection with FIG. 3.

Referring back to FIG. 4, the platform 208 further includes a syntactic matching engine 430 coupled to the category processing module 420. The syntactic matching engine 420 is a hardware and/or software module configured to select advertisements that match the query keywords of the search query received from the user.

In one embodiment, each database within the entity 200 may, in one embodiment, be implemented as a relational database, or may, in an alternate embodiment, be implemented as a collection of objects in an object-oriented database. In one embodiment, the content database 209 stores a plurality of web pages and associated content information, each web page being classified according to one or more categories. The advertising database 208 stores a plurality of advertisements and associated advertising content information, each advertisement being classified according to one or more categories, which characterize the general subject matter of each advertisement.

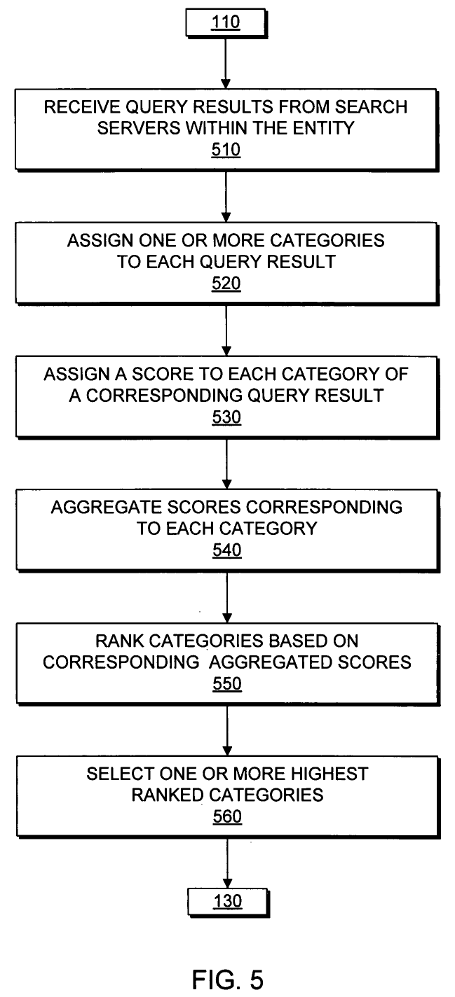

FIG. 5 is a flow diagram illustrating a method to facilitate classification of search queries, according to one embodiment of the invention. The processing sequence described in FIG. 5 accomplishes the classification of query results, as described above at processing block 120 of FIG. 1.

In one embodiment, the user accesses a web page displayed in the client program 230 of the client machine 232 and transmits a search query to the entity 200 via the client machine 232 and the network 220. The search servers 204 receive the search query via the web servers 202 and perform query processing, as described above at processing block 110 of FIG. 1. Generally, the search servers 204 parse the search query into one or more query terms or keywords and retrieve a predetermined number of query results from one or more data storage modules within the entity 200, such as, for example, from the content database 209. Subsequently, the search servers 204 transmit the query results and the parsed query to the query classification platform 208 within the entity 200. In one embodiment, if the search query received from the user is “Latin Canon,” the search servers 204 parse the query into keywords “Latin,” “Canon,” and the expression “Latin Canon” and retrieve a set of query results related to the above parsed keywords from the content database 209.

As illustrated in FIG. 5, at processing block 510, query results are received from the search servers 204 within the entity 200. In one embodiment, the classification module 310 or 410 within the platform 208 receives the predetermined number of query results from the search servers 204. The query results may include complete web pages related to the search query or, in the alternative, summaries of the web pages, which contain one or more of the query keywords.

At processing block 520, one or more categories are assigned to each received query result. In one embodiment, the classification module 310 (410) accesses the content database 209 and retrieves one or more categories for each query result based on content information associated with each query result, such as, for example, the complete web page representation of each query result, or, in the alternative, a summary associated with each query result. In one embodiment, the classification module 310 (410) matches the topic of each query result with one or more categories stored within the content database 209. For example, considering the search query “Latin Canon,” and a set of query results X (a web page related to religious books), Y (a web page related to religious camps), and Z (a web page related to photography magazines) associated with the above query, the classification module 310 may retrieve matching topical categories as follows:

X—category C1 (Religion) and category C2 (Literature);

Y—category C1 (Religion) and category C3 (Travel);

Z—category C2 (Literature) and category C4 (Photography).

Alternatively, the classification module 310 (410) may match a geographic parameter pertaining to each query result with one or more categories stored within the content database 209. In yet another alternate embodiment, the classification module 310 (410) may match a demographic parameter pertaining to each query result with one or more categories stored within the content database 209. However, it is to be understood that any parameter related to the query results may be used to retrieve matching categories from the content database 209.

At processing block 530, a score is assigned to each category of a corresponding query result. In one embodiment, the classification module 310 (410) transmits the query results and respective categories to the category processing module 320 (420). The category processing module 320 (420) assigns a score to each retrieved category, the score being defined as a confidence that the respective category properly classifies the corresponding query result. In one embodiment, the value of each score is between a 0 and a 1 integer value. Alternatively, the category processing module 320 (420) may assign any number to each category associated with a query result, as long as the numbers represent confidence levels corresponding to each category.

In the above example, the category processing module 320 (420) may assign confidence scores as follows:

Query result X/category C1 may receive a score S1;

Query result X/category C2 may receive a score S2;

Query result Y/category C1 may receive a score S3;

Query result Y/category C3 may receive a score S4;

Query result Z/category C2 may receive a score S5;

Query result Z/category C4 may receive a score S6.

At processing block 540, scores corresponding to a respective category are aggregated. In one embodiment, the category processing module 320 (420) aggregates all scores pertaining to a respective category and produces a resulting score, which characterizes the overall confidence that the respective category may extrapolate to the entire set of query results. The category processing module 320 (420) may, for example, perform the following aggregations:

For category C1, the overall resulting score is S_{C1}=S1+S3;

For category C2, the overall resulting score is S_{C2}=S2+S5;

For category C3, the overall resulting score is S_{C3}=S4; and

For category C4, the overall resulting score is S_{C4}=S6.

At processing block 550, the categories are ranked according to their corresponding resulting aggregated scores. In one embodiment, the category processing module 320 (420) ranks all categories according to their respective overall resulting scores to obtain a ranked list of categories. In one embodiment, if S_{C1}>S_{C2}>S_{C3}>S_{C4}, then the list of categories is C1-C2-C3-C4, with C1 as the most significant category and C4 as the least significant category.

Finally, at processing block 560, one or more highest ranked categories are selected for further processing. In one embodiment, the category processing module 320 (420) selects one or more top ranked categories, for example category C1 (Religion) and transmits the selected category or categories to the advertising servers 206 for further selection of advertising information, as described at processing block 130 of FIG. 1.

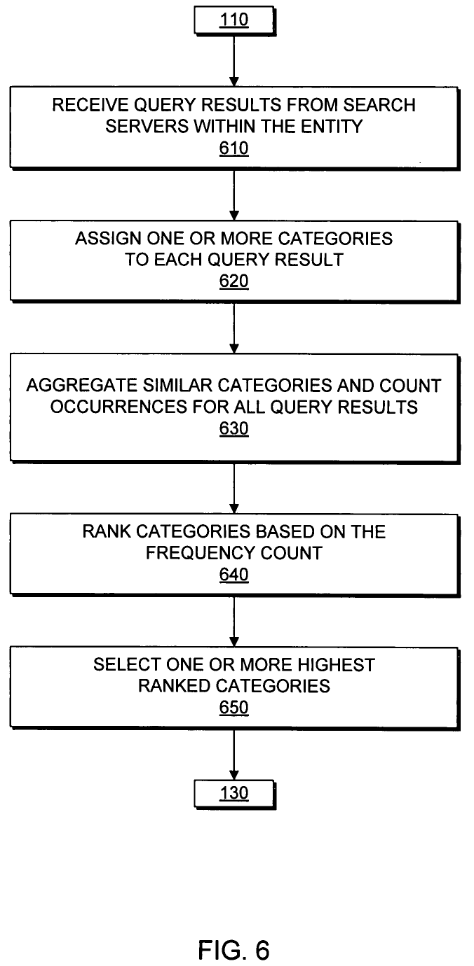

FIG. 6 is a flow diagram illustrating a method to facilitate classification of queries, according to an alternate embodiment of the invention. The processing sequence described in FIG. 6 accomplishes the classification of query results, as described above at processing block 120 of FIG. 1.

In one embodiment, the user accesses a web page displayed in the client program 230 of the client machine 232 and transmits a search query to the entity 200 via the client machine 232 and the network 220. The search servers 204 receive the search query via the web servers 202 and perform query processing, as described above at processing block 110 of FIG. 1. Generally, the search servers 204 parse the search query into one or more query terms or keywords and retrieve a predetermined number of query results from one or more data storage modules within the entity 200, such as, for example, from the content database 209. Subsequently, the search servers 204 transmit the query results and the parsed query to the query classification platform 208 within the entity 200. In one embodiment, if the search query received from the user is “Latin Canon,” the search servers 204 parse the query into keywords “Latin,” “Canon,” and the expression “Latin Canon” and retrieve a set of query results related to the above parsed keywords from the content database 209.

As illustrated in FIG. 6, at processing block 610, query results are received from the search servers 204 within the entity 200. In one embodiment, the classification module 310 (410) within the platform 208 receives the predetermined number of query results from the search servers 204. The query results may include complete web pages related to the search query or, in the alternative, summaries of the web pages, which contain one or more of the query keywords.

At processing block 620, one or more categories are assigned to each received query result. In one embodiment, the classification module 310 (410) accesses the content database 209 and retrieves one or more categories for each query result based on content information associated with each query result, such as, for example, the complete web page representation of each query result, or, in the alternative, a summary associated with each query result. In one embodiment, the classification module 310 (410) matches the topic of each query result with one or more categories stored within the content database 209. For example, considering the search query “Latin Canon,” and a set of query results X (a web page related to religious books), Y (a web page related to religious camps), and Z (a web page related to photography magazines) associated with the above query, the classification module 310 may retrieve matching topical categories as follows:

X—category C1 (Religion) and category C2 (Literature);

Y—category C1 (Religion) and category C3 (Travel);

Z—category C2 (Literature) and category C4 (Photography).

Alternatively, the classification module 310 (410) may match a geographic parameter pertaining to each query result with one or more categories stored within the content database 209. In yet another alternate embodiment, the classification module 310 (410) may match a demographic parameter pertaining to each query result with one or more categories stored within the content database 209. However, it is to be understood that any parameter related to the query results may be used to retrieve matching categories from the content database 209.

At processing block 630, similar categories are aggregated and their occurrences within the entire set of query results are counted. In one embodiment, the category processing module 320 (420) aggregates all categories and counts each occurrence of each category within the set of query results. The category processing module 320 (420) may, for example, perform the following aggregations:

Category C1 appears twice, in query results X and Y, and its overall count is thus 2;

Category C2 appears twice, in query results X and Z, and its overall count is thus 2;

Category C3 appears once, in query result Y, and its overall count is thus 1; and

Category C4 appears once, in query result Z, and its overall count is thus 1.

Alternatively, the actual aggregation of categories may be performed according to one of many known aggregation techniques, and/or according to known formulas derived from machine learning algorithms.

At processing block 640, the categories are ranked according to their corresponding resulting aggregated count values. In one embodiment, the category processing module 320 (420) ranks all categories according to their respective overall count values to obtain a ranked list of categories. In one embodiment, the list of categories is C1-C2-C3-C4, with C1 and C2 as the most significant categories and C3 and C4 as the least significant categories.

Finally, at processing block 650, one or more highest ranked categories are selected for further processing. In one embodiment, the category processing module 320 (420) selects one or more top ranked categories, for example category C1 (Religion) and category C2 (Literature) and transmits the selected categories to the advertising servers 206 for further selection of advertising information, as described at processing block 130 of FIG. 1.

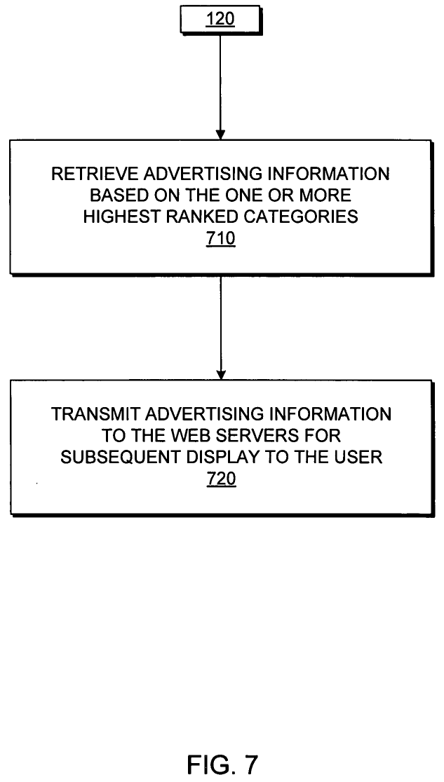

FIG. 7 is a flow diagram illustrating a method to facilitate selection of advertising information associated with the classified queries, according to one embodiment of the invention. The processing sequence described in FIG. 7 accomplishes the selection of advertising information, as described above at processing block 130 of FIG. 1.

As illustrated in FIG. 7, the processing sequence starts with processing block 120 of FIG. 1. At processing block 710, advertising information is retrieved from the advertising database 207 based on the one or more highest ranked categories in the ranked list of categories. In one embodiment, the advertising servers 206 receive the highest ranked category or categories from the category processing module 320 (420) within the platform 208. The advertising servers 206 further access the advertising database 207 to retrieve advertising information pertaining to the received categories. The advertising information includes advertisements stored by advertiser entities in the respective categories within the advertising database 207.

At processing block 720, the advertising information is transmitted to the web servers 202 for subsequent display to the user. In one embodiment, the advertising servers 206 transmit the retrieved advertising information to the web servers 202. The web servers 202 further transmit the query results and the related advertising information to the client machine 232 via the network 220 for display on the client program 230 of the client machine 232.

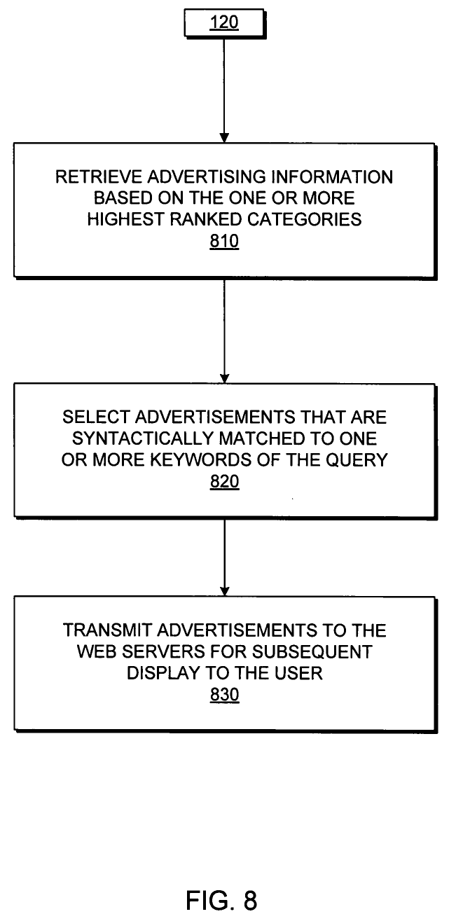

FIG. 8 is a flow diagram illustrating a method to facilitate selection of advertising information associated with the classified queries, according to an alternate embodiment of the invention. The processing sequence described in FIG. 8 accomplishes the selection of advertising information, as described above at processing block 130 of FIG. 1.

As illustrated in FIG. 8, the processing sequence starts with processing block 120 of FIG. 1. At processing block 810, advertising information is retrieved from the advertising database 207 based on the one or more highest ranked categories in the ranked list of categories. In one embodiment, the advertising servers 206 receive the highest ranked category or categories from the category processing module 320 (420) within the platform 208. The advertising servers 206 further access the advertising database 207 to retrieve advertising information pertaining to the received categories. The advertising information includes advertisements stored by advertiser entities in the respective categories within the advertising database 207.

At processing block 820, advertisements that are syntactically matched to one or more query keywords of the search query are selected. In one embodiment, the advertising servers 206 communicate with the syntactic matching module 430 within the platform 208 to filter the retrieved advertising information and to select advertisements that match the query keywords.

In one embodiment, the syntactic matching module 430 receives the query keywords from the search servers 204 and matches advertisements based on the extracted query keywords. The advertising servers 206 subsequently select the matched advertisements for further transmission to the web servers 202.

Finally, at processing block 830, the selected advertisements are transmitted to the web servers 202 for subsequent display to the user. In one embodiment, the advertising servers 206 transmit the selected advertisements to the web servers 202. The web servers 202 further transmit the query results and the related advertisements to the client machine 232 via the network 220 for display on the client program 230 of the client machine 232.

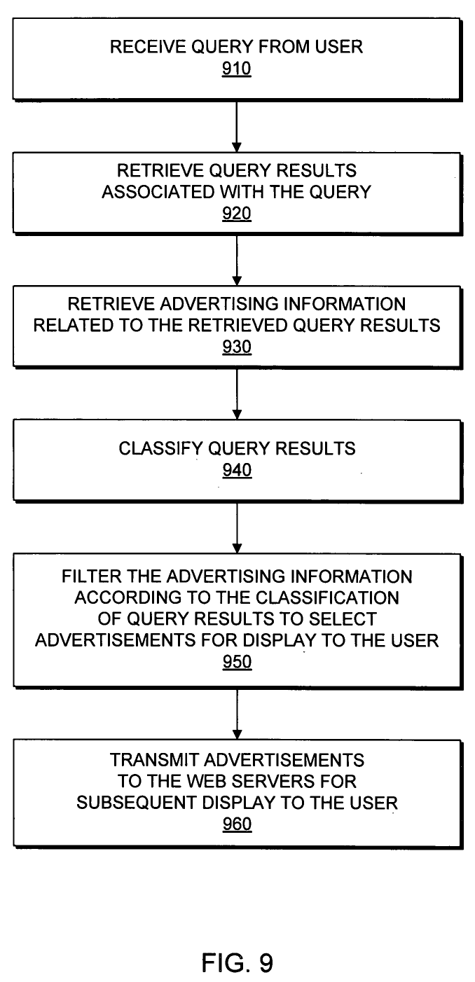

FIG. 9 is a flow diagram illustrating a method to facilitate classification of queries and selection of associated advertising information, according to an alternate embodiment of the invention. As illustrated in FIG. 9, at processing block 910, a search query is received from a user. In one embodiment, the user accesses a web page displayed in the client program 230 of the client machine 232 and transmits a search query to the entity 200 via the client machine 232 and the network 220. The search servers 204 receive the search query via the web servers 202.

At processing block 920, query results associated with the search query are retrieved. In one embodiment, the search servers 204 parse the search query into one or more query terms or keywords and retrieve a predetermined number of query results from one or more data storage modules within the entity 200, such as, for example, from the content database 209. Subsequently, the search servers 204 transmit the query results and the parsed query to the advertising servers 206 within the entity 200.

At processing block 930, advertising information related to the retrieved query results is retrieved. In one embodiment, the advertising servers 206 access the advertising database 207 to retrieve advertising information pertaining to each query result. The advertising information includes advertisements stored by advertiser entities in respective categories within the advertising database 207.

At processing block 940, the query results are classified. In one embodiment, the query classification platform 208 classifies the set of query results, as described in detail above in connection with FIGS. 5, 6.

At processing block 950, the advertising information is filtered according to the query result classification to select advertisements for further display to the user. In one embodiment, the classification of query results outputs one or more categories associated with the set of query results, as shown in FIGS. 5, 6. The advertising servers 206 use the retrieved categories to filter the advertising information to select only advertisements related to the specific categories and to discard the remaining advertisements.

Next, at processing block 960, the advertising servers 206 transmit the selected advertisements to the web servers 202 for display on the client program 230 of the client machine 232 of the user.

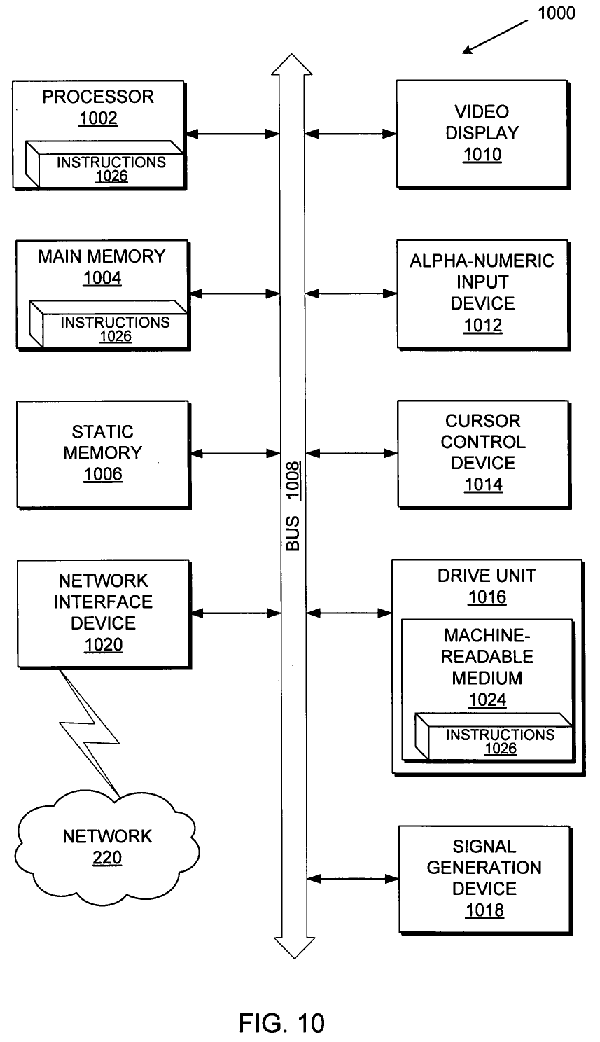

FIG. 10 shows a diagrammatic representation of a machine in the exemplary form of a computer system 1000 within which a set of instructions, for causing the machine to perform any one of the methodologies discussed above, may be executed. In alternative embodiments, the machine may comprise a network router, a network switch, a network bridge, Personal Digital Assistant (PDA), a cellular telephone, a web appliance or any machine capable of executing a sequence of instructions that specify actions to be taken by that machine.

The computer system 1000 includes a processor 1002, a main memory 1004 and a static memory 1006, which communicate with each other via a bus 1008. The computer system 1000 may further include a video display unit 1010 (e.g., a liquid crystal display (LCD) or a cathode ray tube (CRT)). The computer system 1000 also includes an alphanumeric input device 1012 (e.g., a keyboard), a cursor control device 1014 (e.g., a mouse), a disk drive unit 1016, a signal generation device 1018 (e.g., a speaker), and a network interface device 1020.

The disk drive unit 1016 includes a machine-readable medium 1024 on which is stored a set of instructions (i.e., software) 1026 embodying any one, or all, of the methodologies described above. The software 1026 is also shown to reside, completely or at least partially, within the main memory 1004 and/or within the processor 1002. The software 1026 may further be transmitted or received via the network interface device 1020 over the network 220.

It is to be understood that embodiments of this invention may be used as or to support software programs executed upon some form of processing core (such as the CPU of a computer) or otherwise implemented or realized upon or within a machine or computer readable medium. A machine readable medium includes any mechanism for storing or transmitting information in a form readable by a machine (e.g., a computer). For example, a machine readable medium includes read-only memory (ROM); random access memory (RAM); magnetic disk storage media; optical storage media; flash memory devices; electrical, optical, acoustical or other form of propagated signals (e.g., carrier waves, infrared signals, digital signals, etc.); or any other type of media suitable for storing or transmitting information.

In the foregoing specification, the invention has been described with reference to specific exemplary embodiments thereof. It will, however, be evident that various modifications and changes may be made thereto without departing from the broader spirit and scope of the invention as set forth in the appended claims. The specification and drawings are, accordingly, to be regarded in an illustrative sense rather than a restrictive sense.

What is claimed is:

1. A method comprising:
processing a query received from a user over a network to retrieve a predetermined number of query results;
classifying said predetermined number of query results to select at least one category associated with said query results; and
selecting advertising information based on said at least one category for further display to said user in connection with said query results.

2. The method according to claim 1, wherein said processing further comprises:
parsing said query to obtain at least one query keyword; and
retrieving said predetermined number of query results from at least one data storage module based on said at least one query keyword.

3. The method according to claim 1, wherein said classifying further comprises:
retrieving at least one category for each query result from at least one data storage module based on content information associated with said each query result.

4. The method according to claim 3, wherein said content information further comprises a complete web page representation of said each query result.

5. The method according to claim 3, wherein said content information further comprises a summary associated with said each query result.

6. The method according to claim 3, wherein said retrieving further comprises:
matching a topic of said each query result with said at least one category.

7. The method according to claim 3, wherein said retrieving further comprises:
matching a geographic parameter pertaining to said each query result with said at least one category.

8. The method according to claim 3, wherein said retrieving further comprises:
matching a demographic parameter pertaining to said each query result with said at least one category.

9. The method according to claim 3, wherein said classifying further comprises:
assigning a score to each retrieved category, said score representing a confidence level that said each category accurately characterizes said corresponding query result;
aggregating scores corresponding to said each category to obtain a resulting score assigned to said each category; and
ranking said each category based on said corresponding resulting score.

10. The method according to claim 9, wherein selecting said advertising information further comprises:
retrieving said advertising information associated with said at least one category selected as highest ranked based on said corresponding resulting score; and
transmitting said advertising information with said predetermined number of query results to said user.

11. The method according to claim 10, wherein retrieving said advertising information further comprises:
filtering said advertising information to select advertisements that syntactically match at least one query keyword of said query.

12. The method according to claim 3, wherein said classifying further comprises:
aggregating similar categories of said at least one retrieved category to calculate a count value associated with each category; and
ranking said each category based on said corresponding count value.

13. The method according to claim 12, wherein selecting said advertising information further comprises:
retrieving said advertising information associated with said at least one category selected as highest ranked based on said corresponding count value; and
transmitting said advertising information with said predetermined number of query results to said user.

14. A method comprising:
processing a query received from a user over a network to retrieve a predetermined number of query results;
selecting advertising information based on said query results;
classifying said predetermined number of query results to select at least one category associated with said query results; and
filtering said advertising information to retrieve advertisements related to said at least one category for further display to said user.

15. The method according to claim 14, wherein said classifying further comprises:
retrieving at least one category for each query result from at least one data storage module based on content information associated with said each query result.

16. The method according to claim 15, wherein said classifying further comprises:
assigning a score to each retrieved category, said score representing a confidence level that said each category accurately characterizes said corresponding query result;
aggregating scores corresponding to said each category to obtain a resulting score assigned to said each category; and
ranking said each category based on said corresponding resulting score.

17. The method according to claim 16, wherein said filtering further comprises:
selecting said advertisements associated with said at least one category selected as highest ranked based on said corresponding resulting score; and
transmitting said advertisements with said predetermined number of query results to said user.

18. The method according to claim 15, wherein said classifying further comprises:
aggregating similar categories of said at least one retrieved category to calculate a count value associated with each category; and
ranking said each category based on said corresponding count value.

19. The method according to claim 18, wherein said filtering further comprises:
selecting said advertisements associated with said at least one category selected as highest ranked based on said corresponding count value; and
transmitting said advertisements with said predetermined number of query results to said user.

20. An apparatus comprising:
at least one search server to process a query received from a user over a network to retrieve a predetermined number of query results;
a query classification platform coupled to said at least one search server to receive said predetermined number of query results and to classify said query results in order to select at least one category associated with said query results; and
at least one advertising server coupled to said query classification platform to select advertising information based on said at least one category for further display to said user in connection with said query results.

21. The apparatus according to claim 20, wherein said at least one search server further parses said query to obtain at least one query keyword, and retrieves said predetermined number of query results from at least one data storage module based on said at least one query keyword.

22. The apparatus according to claim 20, wherein said query classification platform further comprises a classification module to retrieve at least one category for each query result from at least one data storage module based on content information associated with said each query result.

23. The apparatus according to claim 22, wherein said query classification platform further comprises a category processing module to assign a score to each retrieved category, said score representing a confidence level that said each category accurately characterizes said corresponding query result, further to aggregate scores corresponding to said each category to obtain a resulting score assigned to said each category, and to rank said each category based on said corresponding resulting score.

24. The apparatus according to claim 23, wherein said at least one advertising server further retrieves said advertising information associated with said at least one category selected by said category processing module within said query processing platform as highest ranked based on said corresponding resulting score, and transmits said advertising information with said predetermined number of query results to said user.

25. The apparatus according to claim 24, wherein said query classification platform further comprises a syntactic matching module to filter said retrieved advertising information to select advertisements that syntactically match at least one query keyword of said query.

26. The apparatus according to claim 22, wherein said query classification platform further comprises a category processing module to aggregate similar categories of said at least one retrieved category and to calculate a count value associated with each category, and further to rank said each category based on said corresponding count value.

27. The apparatus according to claim 26, wherein said at least one advertising server further retrieves said advertising information associated with said at least one category selected by said category processing module within said query processing platform as highest ranked based on said corresponding count value, and transmits said advertising information with said predetermined number of query results to said user.

28. An apparatus comprising:
at least one search server to process a query received from a user over a network to retrieve a predetermined number of query results;
at least one advertising server coupled to said at least one search server to select advertising information based on said query results; and
a query classification platform coupled to said at least one search server and said at least one advertising server, said query classification platform to classify said predetermined number of query results in order to select at least one category associated with said query results;
said at least one advertising server to receive said at least one category and further to filter said advertising information in order to retrieve advertisements related to said at least one category for further display to said user.

29. The apparatus according to claim 28, wherein said query classification platform further comprises a classification module to retrieve at least one category for each query result from at least one data storage module based on content information associated with said each query result.

30. The apparatus according to claim 29, wherein said query classification platform further comprises a category processing module to assign a score to each retrieved category, said score representing a confidence level that said each category accurately characterizes said corresponding query result, further to aggregate scores corresponding to said each category to obtain a resulting score assigned to said each category, and to rank said each category based on said corresponding resulting score.

31. The apparatus according to claim 30, wherein said at least one advertising server further selects said advertisements associated with said at least one category selected by said category processing module within said query processing platform as highest ranked based on said corresponding resulting score, and transmits said advertisements with said predetermined number of query results to said user.

32. The apparatus according to claim 29, wherein said query classification platform further comprises a category processing module to aggregate similar categories of said at least one retrieved category and to calculate a count value associated with each category, and further to rank said each category based on said corresponding count value.

33. The apparatus according to claim 32, wherein said at least one advertising server further selects said advertisements associated with said at least one category selected by said category processing module within said query processing platform as highest ranked based on said corresponding count value, and transmits said advertisements with said predetermined number of query results to said user.

34. A computer readable medium containing executable instructions, which, when executed in a processing system, cause said processing system to perform a method comprising:
processing a query received from a user over a network to retrieve a predetermined number of query results;
classifying said predetermined number of query results to select at least one category associated with said query results; and
selecting advertising information based on said at least one category for further display to said user in connection with said query results.

35. The computer readable medium according to claim 34, wherein said processing further comprises:
parsing said query to obtain at least one query keyword; and
retrieving said predetermined number of query results from at least one data storage module based on said at least one query keyword.

36. The computer readable medium according to claim 34, wherein said classifying further comprises:
retrieving at least one category for each query result from at least one data storage module based on content information associated with said each query result.

37. The computer readable medium according to claim 36, wherein said content information further comprises a complete web page representation of said each query result.

38. The computer readable medium according to claim 36, wherein said content information further comprises a summary associated with said each query result.

39. The computer readable medium according to claim 36, wherein said retrieving further comprises:
matching a topic of said each query result with said at least one category.

40. The computer readable medium according to claim 36, wherein said retrieving further comprises:
matching a geographic parameter pertaining to said each query result with said at least one category.

41. The computer readable medium according to claim 36, wherein said retrieving further comprises:
matching a demographic parameter pertaining to said each query result with said at least one category.

42. The computer readable medium according to claim 36, wherein said classifying further comprises:
assigning a score to each retrieved category, said score representing a confidence level that said each category accurately characterizes said corresponding query result;
aggregating scores corresponding to said each category to obtain a resulting score assigned to said each category; and
ranking said each category based on said corresponding resulting score.

43. The computer readable medium according to claim 42, wherein selecting said advertising information further comprises:
retrieving said advertising information associated with said at least one category selected as highest ranked based on said corresponding resulting score; and
transmitting said advertising information with said predetermined number of query results to said user.

44. The computer readable medium according to claim 43, wherein retrieving said advertising information further comprises:
filtering said advertising information to select advertisements that syntactically match at least one query keyword of said query.

45. The computer readable medium according to claim 36, wherein said classifying further comprises:
aggregating similar categories of said at least one retrieved category to calculate a count value associated with each category; and
ranking said each category based on said corresponding count value.

46. The computer readable medium according to claim 45, wherein selecting said advertising information further comprises:
retrieving said advertising information associated with said at least one category selected as highest ranked based on said corresponding count value; and
transmitting said advertising information with said predetermined number of query results to said user.

47. A computer readable medium containing executable instructions, which, when executed in a processing system, cause said processing system to perform a method comprising:
processing a query received from a user over a network to retrieve a predetermined number of query results;
selecting advertising information based on said query results;
classifying said predetermined number of query results to select at least one category associated with said query results; and
filtering said advertising information to retrieve advertisements related to said at least one category for further display to said user.

48. The computer readable medium according to claim 47, wherein said classifying further comprises:
retrieving at least one category for each query result from at least one data storage module based on content information associated with said each query result.

49. The computer readable medium according to claim 48, wherein said classifying further comprises:
assigning a score to each retrieved category, said score representing a confidence level that said each category accurately characterizes said corresponding query result;
aggregating scores corresponding to said each category to obtain a resulting score assigned to said each category; and
ranking said each category based on said corresponding resulting score.

50. The computer readable medium according to claim 49, wherein said filtering further comprises:
selecting said advertisements associated with said at least one category selected as highest ranked based on said corresponding resulting score; and
transmitting said advertisements with said predetermined number of query results to said user.

51. The computer readable medium according to claim 48, wherein said classifying further comprises:
aggregating similar categories of said at least one retrieved category to calculate a count value associated with each category; and
ranking said each category based on said corresponding count value.

52. The computer readable medium according to claim 51, wherein said filtering further comprises:
selecting said advertisements associated with said at least one category selected as highest ranked based on said corresponding count value; and
transmitting said advertisements with said predetermined number of query results to said user.
